(19) United States
(12) Patent Application Publication
(10) Pub. No.: US 2005/0090418 A1
(43) Pub. Date: Apr. 28, 2005

(54) Washing agent for an automatic dishwasher

(75) Inventor: Moriichi Mizuno, Aichi (JP)

Correspondence Address: Donald S. Dowden;Cooper & Dunham LLP, 1185 Avenue of the Americas, New York, NY, 10036, US

(73) Assignee: Kumano Yushi Co., Ltd., Seto-shi (JP)

(21) Appl. No.: 10/996,624

(22) Filed: Nov. 23, 2004

(30) Foreign Application Priority Data
Aug. 21, 2003 (JP) JP2003-297058

(51) Int. Cl. C11D 1/00

(52) U.S. Cl. 510/220

(57) ABSTRACT

The object of the present invention is to provide a washing agent for an automatic dishwasher, being less foamy and less corrosive, and having excellent washing ability. A washing agent for an automatic dishwasher is provided in the present invention. Said washing agent contains a homopolymer of a vinyl monomer having a hydrophilic group, or a copolymer of said vinyl monomer having a hydrophilic group and another vinyl monomer, wherein 30 to 70% by weight of said hydrophilic group is contained in said vinyl monomer, and the pH of the 120 ppm aqueous solution of said homopolymer or said copolymer is in the range of between 5 and 10. Said washing agent foams little, is negligibly corrosive, and has an excellent washing ability.

### FIELD OF THE INVENTION

The present invention relates to a washing agent for an automatic dishwasher.

### BACKGROUND OF THE INVENTION

The conventional washing agent for an automatic dishwasher contains alkali agents such as sodium hydroxide, potassium hydroxide, phosphate, silicate and the like as its main components (refer to patent documents cited 1 to 5).

Said washing agent, however, being a strong alkali, raises concerns regarding corrosion of dishes and said waste washing solution's alkali content polluting the environment. Henceforth, a non-alkali washing agent containing a nonionic active surface agent as its main component is provided (refer to patent documents cited 6 to 8).
Patent document cited 1; Tokkaihei11-181475
Patent document cited 2; JP2002-3892
Patent document cited 3; Tokkaihei03-100100
Patent document cited 4; Tokkaihei05-78697
Patent document cited 5; Tokkaihei01-198699
Patent document cited 6; Tokkaihei06-33100
Patent document cited 7; Tokkaihei11-61179
Patent document cited 8; JP2000-144181

### DISCLOSURE OF THE INVENTION

Nevertheless, said washing agent containing nonionic surface active agent as its main component has a foamy property, its problem being that a large volume of foam is produced when said washing agent is sprayed on dishes in an automatic dishwasher.

Accordingly, the present invention provides a washing agent for an automatic dishwasher, containing a homopolymer of a vinyl monomer having a hydrophilic group or a copolymer of said vinyl monomer having a hydrophilic group and another vinyl monomer, wherein 30 to 70% by weight of hydrophilic group is contained in said vinyl monomer and the PH of the 120 ppm aqueous solution of said homopolymer or said copolymer is in the range of between 5 and 10.

It is preferable that said hydrophilic a group is carboxyl group, sulfonic acid group, or quaternary ammonium salt group, and weigh average molecular weight of said homopolymer or said copolymer is preferably in the range between 500 and 500,000.

Further, a water soluble polysaccharide such as cyclodextrin and/or a cyclodextrin derivative or the like is(are) preferably added to said washing agent of the present invention, and furthermore, inorganic salt or inorganic powder is preferably added to said washing agent. Still further, an enzyme is preferably added in said washing agent.

### DETAILED DESCRIPTION OF THE INVENTION

Said washing agent of the present invention provides substantially neutral washing solution, and has less foamy and corrosive, and has an excellent washing ability.

The washing agent of the present invention contains a homopolymer of vinyl monomer having a hydrophilic group, or a copolymer of said vinyl monomer having hydrophilic group and another vinyl monomer as its main component. A desirable hydrophilic group may be carboxyl group (—COOH), sulfonic acid group(—SO3 H), a quaternary ammonium salt group (—(NR₃ )X, wherein R is an alkyl group or aryl group, and X is a halogen element) or the like, and further, other hydrophilic groups such as the acid amide group, hydroxyl group and the like may be included in said hydrophilic group of present invention.

Said vinyl monomer having a carboxyl group may be such as α, β unsaturated fatty acid having one or more carboxyl group(s) such as acrylic acid, methacrylic acid, itaconic acid, crotonic acid, atropic acid, citraconic acid, maleic acid, fumaric acid or the like, or α, β unsaturated fatty acid anhydride such as maleic anhydride, itaconic anhydride, citraconic anhydride or the like.

Said vinyl monomer having a sufonic acid group may be such as sullfonide of vinyl monomer having aromatic ring such as 2-acrylamide2-methylpropansulfonic acid, sulfoethylacrylate, sulfoethylmethacrylate, vinylsulfonic acid, or the like, or styrenesulfonic acid, α-methylstyrenesulfonic acid, α-ethylstyrenesulfonic acid, α-methylvinyltoluenesulfonic acid, or the like.

Said vinyl monomer having a quaternary ammonium salt group may be such as vinyl monomer containing quaternary ammonium salt base which is produced by reaction between tertiary amine compound having polymerizable unsaturated bond and alkylating agent such as halogeneted alkyl ,alkyl sulfonate or the like, said vinyl monomer containing quaternary ammonium salt base may be such as dimethylaminoethylacrylate, dimethylaminoethylmethacrylate, dimethylaminoisopropylacrylate, dimethylaminoisopropylmethacrylate or the like.

Said vinyl monomer having another hydrophilic group may be such as amide acrylate, amide methacrylate, diacetoneacrylamide, β-hydroxyethylacrylate, β-hydroxyethylmethacrylate, β-hydroxypropylacrylate, β-hydroxypropylmethacrylate or the like, further saponfied vinyl acetate may be used as said polymer containing hydrophilic group.

Another vinyl monomer copolymerized with said vinyl monomer having hydrophilic group may be such as aliphatic or cyclic acrylate and methacrylate such as methylacrylate, ethylacrylate, n-propylacrylate, iso-propylacrylate, n-butylacrylate, iso-butylacrylate, t-butylacrylat, 2-ethylhexylacrylate, cyclohexylacrylate, tetrahydrofurfurylacrylate, methylmethacrylate, ethylmethacrylate, n-propylmethacrylate, iso-propylmethacrylate, n-butylmethacrylate, iso-butylmethacrylate, 2-ethylhexylmethacrylate, cyclohexylmethacrylate, tetrahydrofurfurylmethacrylate, stearylmethacrylate, laurylmethacrylate or the like, vinylether such as methylvinylether, ethylvinylether, n-propylvinylether, n-butylvinylether, iso-butylvinylether or the like, styrene such as styrene, α-methylstyrene or the like, nitrile monomer such as acrylonitrile, methacrylonitrile or the like, fatty acid vinyl such as vinyl acetate, vinyl propionate or the like, monomer having halogen such as vinyl chloride, vinylidene chloride, vinyl fluoride vinylidene fluoride or the like, monomer having epoxy group such as glycidylmethacrylate, glycidylallylether or the like, another water-soluble monomer such as vinylpyrrolidone, vinylpyridine, vinylcarbazole, or the like.

A mixture of two or more kinds of said vinyl monomer may be used in the present invention.

Said vinyl monomer(s) is(are) ordinarily (co)polymerized in an aqueous medium, but said vinyl monomer(s) may also be emulsion (co) polymerized, or (co)polymerized in water soluble organic solvent, such as methanol, ethanol, isopropanol, acetate, or the like, or in a mixture of water and said water soluble solvent.

The washing agent of the present invention must contain 30 to 70% by weight of a hydrophilic group in said homopolymer or copolymer. In a case where a hydrophilic group is contained in said washing agent in an amount of under 30% by weight, the washing ability of said washing agent may be not adequate, while in a case where a hydrophilic group is contained in an amount of more than 70% by weight, said washing agent has a high foamy property.

Further, it is necessary that the pH of said 120ppm aqueous solution of said homopolymer or copolymer is in the range of between 5 and 10, but more desirably 6 and 9. In a case where pH is under 5, the washing ability may be not adequate while in a case where the pH is over 10, dishes may be strongly corroded by said washing agent.

In a case where said hydrophilic group of said homopolymer or copolymer is a carboxyl group or sulfonic acid group, its pH is adjusted by an alkali compound such as alkaline metal hydroxide or carbonate such as potassium hydroxide, sodium hydroxide, potassium carbonate, sodium carbonate or the like, ammonia, an organic amine such as dimethyl amine, diethyl amine, ethanol amine or the like.

In a case where said monopolymer or copolymer has quaternary ammonium salt acid such as hydrochloric acid, sulfuric acid, acetic acid, oxalic acid or the like is used to adjust pH.

The weight average molecular weight of said homopolymer or copolymer may be preferably in the range of between 500 and 500,000, but more preferably 2000 and 300,000. In a case where the weight average molecular weight of said homopolymer or copolymer is under 500, the washing ability of said washing agent may be not adequate, while in a case where the average molecular weight is over 500,000, said washing agent solution becomes too viscous, degrading its spray workability.

Besides said polymer, for instance, an anionic surface active agent such as higher alcoholsulphate(Na salt or amine salt), alkylallylsulfonate((Na salt or amine salt), alkylnaphthalenesulfonate((Na salt or amine salt), alkylnaphthalenesulfonate condensation product, alkylphosphate, dialkylsolfoxylate, rosin soap, fatty acid salt(Na salt or amine salt) or the like, nonionic surface active agent such as polyoxyethylenealkylether, polyoxyethylenealkylphenolether, polyoxyethylenealkylester, polyoxyethylenealkylamine, polyoxyethylenealkylolamine, polyoxyethylenealkylamido, sorbitanalkylester, polyoxyethylene sorbitanalkylester or the like, cathionic surface active agent such as octadecylamineacetate, imidazoline derivative acetate, polyalkylenepolyamine derivative or salt, octadecyltrimethylammoniumchloride, trimethylaminoethylalkylamidohalogenide, alkylpyridinium sulfate, alkyltrimethylammoniumhalogenide or the like, a coloring material, incense, disinfectant, mildew proofing agent, bleach, chelate agent, enzyme, essential oil or the like, may be added to said washing agent of the present invention. In the case of said surface active agent, said surface active agent may be added to said polymer in an amount of less than 40 parts by weight to 100 parts by weight of said polymer, and to minimize spray foaming, said surface active agent may be added in an amount of less than 0.5 parts by weight, desirably less than 0.3 parts by weight, and ideally in an amount of less than 0.1 parts by weight. Two or more kinds of said additive may be added and mixed.

Further, to said washing agent of the present invention, a water soluble polysaccharide and/or water soluble polysaccharide derivative may be added. Said water soluble polysaccharide and water soluble polysaccharide derivative may be such as cellulose derivative such as methylcellulose, ethylcellulose, methoxycellulose, ethoxycellulose, carboxymethylcellulose, cationic curing cellulose or the like, starch such as soluble starch, cationic curing starch or the like, dextrin such as dextrin, dextran, cyclodextrin, methyl modified cyclodextrin hydroxypropel modefied cyclodextrin or the like, water soluble gum such as cationic curing guagum, xantan gum, cardran gum, cationic curing Arabia gum curdlan or the like, and alginic acid soda.

In said water soluble polysaccharide or water soluble polysaccharide derivative, cyclodextrin and cyclodextrin derivative may be preferably used. As for said cyclodextrin, any type, α, β, or γ type may be used.

Said water soluble polysaccharide or polysaccharide derivative improves the washing ability of said washing agent, and further, cyclodextrin has deodorizing effect besides improving effect of washing ability.

Said water soluble polysaccharide or polysaccharide derivative is mixed in an amount of between 4 and 40 parts by weight to 100 parts by weight of said homopolymer, or copolymer of the present invention.

Further, an inorganic salt may be added to said washing agent of the present invention. Said inorganic salt may be such as sulfate such as potassium sulfate, sodium sulfate, magnesium sulfate or the like, hydrochloride such as potassium chloride, sodium chloride, magnesium chloride, calcium chloride or the like, phosphate such as potassium phosphate, sodium phosphate or the like. Said inorganic salt may be added in an amount of between 40 and 80 parts by weight to 100 parts by weight of said homopolymer or copolymer of the present invention.

By adding said inorganic salt, the washing ability of said washing agent of the present invention may be further improved.

Sodium sulfate may be preferably used as said inorganic salt.

Still further, enzymes such as protease, amylase, lipase or the like may be added to said washing agent of the present invention. Said enzymes may be added in an amount of more than 1 part by weight to 100 parts by weight of said homopolymer or copolymer of the present invention.

Still further, an inorganic powder may be added to said washing agent of the present invention. Said inorganic powder may be such as bentonite, dycalite, zeolite, perlite, talc, calcium carbonate, magnesium carbonate, barium sulfate, calcium sulfate, calcium sulfite, calcium phosphate, calcium hydroxide, magnesium hydroxide, aluminum hydroxide, magnesium oxide, titanium oxide, iron oxide, zinc oxide, alumina, silica, diatom earth, dolomite, gypsum, clay, mica, carbon fiber, calcium silicate, white carbon, carbon black, iron powder, aluminum powder, stone powder, blast furnace slag, fly ash, zirconia powder or the like.

Said inorganic powder may be added in an amount of between 0.3 and 20 parts by weight to 100 parts by weight of said homopolymer or copolymer of the present invention.

Said washing agent of the present invention is provided mainly as an aqueous solution, however, water soluble solvents such as methanol, ethanol, isopropanol, ethylene glycol, propylene glycol, glycerin, acetone, tetrahydrofuron, or the like or a mixture of said solvent and water may be used as an alternative. The concentration of said polymer may be usually in the range of between 5 and 50% by weight.

When said washing agent of the present invention is used, said washing agent is diluted with water so that the usual concentration of said polymer will be 100 to 150 ppm. As aforementioned, in said washing agent of the present invention, the pH of the 120 ppm aqueous solution of said polymer is adjusted to be between 5 and 10, but more desirably 6 and 9, so that the pH of the concentration of said polymer being used, being between 100 and 150 ppm, may be between about 5 and 10, but more desirably between about 6 and 9, said dilute solution having a superior washing ability with minimal corrosive and decreased foaming properties.

EXAMPLES described in further detail are as below.

### EXAMPLE 1

(Producing Polymer 1)

The thirty parts by weight of methacrylic acid, and 70 parts by weight of deionized water were put in a reactor with a stirrer and condenser, following which 0.1 parts by weight of potassium persulfate was put in the reactor, after which the resulting mixture was stirred while being heated at 75° C., for 6 hours, to produce an aqueous solution of polymethacrylic acid having an weight average molecular weight of 170,000 (polymer 1).
Molecular weight of methacrylic acid 86
Molecular weight of carboxyl group (—COOH) 45

Carboxyl group content in said polymer 45/86=52.33% by weight

### EXAMPLE 2

(Producing Polymer 2)

The thirty parts by weight of styrene sulfonic acid, 10 parts by weight of ethyl acrylate, 50 parts by weight of ethanol, and 10 parts by weight of water were put in the reactor the same as in EXAMPLE 1, then 0.2 parts by weight of tertiary butyl hydroperoxide was put in the reactor and stirred, while being heated at 70° C., for 8 hours, to produce an aqueous solution of copolymer of styrene sulfonic acid and ethyl acrylate, having an weight average molecular weight of 80,000 (polymer 2).

$$\begin{matrix}Molecular weight of styrene sulfonic acid & 184 \times 75 = 13800 \\ Molecular weight of ethyl acrylate & \underline{100 \times 25 = 2500 } \\ & \begin{matrix}Total & 16300\end{matrix}\end{matrix}$$

Molecular weight of sulfonic acid (—SO₃H) 80×75=6000

Content of sulfonic acid in said polymer 6000/16300=36.81% by weight

### EXAMPLE 3

(Producing Polymer 3)

Forty parts by weight of dimethylaminoethyl methacrylate, 50 parts by weight of ethanol, and 10 parts by weight of water were put in the reactor the same as in EXAMPLE 1, then 0.2 parts by weight of tertiary butyl hydroperoxide was put in the reactor and stirred while being heated at 80° C., for 10 hours, to produce an aqueous solution of polymer having an weight average molecular weight of 200,000 (polymer 3).

Eight parts by weight of methyl choloride was put in the resulting polymer solution, then said solution was heated at 70° C., for 4 hours, to produce quaternary ammonium salt, and thus the solution of polymer 3 was prepared.

Molecular weight of dimethyl aminoethyl methacrylate 157

Molecular weight of quaternary ammonium salt 94.5

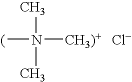

Content of quaternary ammonium salt in said polymer
94.5/157=60.19% by weight

### EXAMPLE4

(Preparation of the Washing Solution)

The solutions of polymers 1 and 2 produced in EXAMPLES 1 and 2 were diluted with water to be 12% by weight of the polymer concentration, after which 4% by weight of sodium sulfate alkyl ether was added to the resulting dilute solutions. Further, the polymer 3 solution prepared in EXAMPLE 3 was diluted with water to be 12% by weight of the polymer concentration, after which 4% by weight of polyoxyethylene alkyl ether was added to the resulting diluted solution. The pH value of each solution was adjusted to be 9 by adding sodium hydroxide.

### EXAMPLE 5

(Washing Test)

Said polymer solutions prepared in EXAMPLE 4 were respectively diluted with water at 1000 times (polymer concentration 120 ppm), and the respective pHs of each solution were adjusted to be various values by using sodium hydroxide or citric acid to prepare test washing solutions.

A dishwasher Smart I-50 type (Yokogawa Denshikiki Co., Ltd.) was used, with the temperature of each test washing solution being adjusted to 60° C., and then each said test washing solution was sprayed for 40 seconds on the articles to be washed, contaminant having been coated on each said article, after which water, heated to 80° C., was sprayed on each article for rinsing. The solutions' forming, contaminants removability, and the corrosive effects on each item washed were estimated by visual observation.

Articles to be washed: glasses, a lacquer coated bowl, a urethane resin coated bowl

Contaminants: mayonnaise, ketchup, salad oil

The results are shown in Tables 1 to 3

For the purpose of comparison, a washing solution having a composition as descried below was prepared.

Comparison 1

| | |
|---|---|
| Potassium hydroxide | 5% by weight |
| No. 2 sodium silicate | 10% by weight |
| EDTA | 10% by weight |

Comparison 2

| | |
|---|---|
| Polyoxyethylene alkyl ether | 5% by weight |
| EDTA | 10% by weight |
| Giethyleneglycolmonobutylether | 5% by weight |

Evaluations of the test results are described below.

Foaming −: little foaming±slight foaming
+: foaming++noticeable foaming

Washing ability ◯: almost clean
□: a little contaminated
Δ: fairly contaminated
×: little change in original contaminants

Corrosion −: surface gloss almost sound
±: surface gloss slightly reduced
+: surface gloss reduced
++: surface gloss noticeably reduced

+++: surface worn

TABLE 1
Article to be washed: Glass

| | | | Washing ability | | | |
|---|---|---|---|---|---|---|
| | | | | | Salad | Corro- |
| Polymer | pH | Foaming | Mayonnaise | Ketchup | Oil | siveness |
| Polymer 1 | 4 | − | X | X | X | − |
| | 5 | − | Δ | □ | Δ | − |
| | 6 | − | □ | ◯ | □ | − |
| | 7 | − | ◯ | ◯ | ◯ | − |
| | 8 | ± | ◯ | ◯ | ◯ | ± |
| | 9 | ± | ◯ | ◯ | ◯ | ± |
| | 10 | ± | ◯ | ◯ | ◯ | + |
| | 11 | + | ◯ | ◯ | ◯ | ++ |
| Polymer 2 | 4 | − | X | X | X | − |
| | 5 | − | □ | □ | □ | − |
| | 6 | − | □ | ◯ | □ | − |
| | 7 | ± | ◯ | ◯ | ◯ | ± |
| | 8 | ± | ◯ | ◯ | ◯ | ± |
| | 9 | ± | ◯ | ◯ | ◯ | + |
| | 10 | ± | ◯ | ◯ | ◯ | ++ |
| | 11 | + | ◯ | ◯ | ◯ | +++ |
| Polymer 3 | 4 | − | X | Δ | X | − |
| | 5 | − | □ | □ | □ | − |
| | 6 | − | ◯ | ◯ | ◯ | − |
| | 7 | − | ◯ | ◯ | ◯ | − |
| | 8 | ± | ◯ | ◯ | ◯ | ± |
| | 9 | ± | ◯ | ◯ | ◯ | ± |
| | 10 | ± | ◯ | ◯ | ◯ | + |
| | 11 | + | ◯ | ◯ | ◯ | ++ |
| Comparison 1 | 11 | + | □ | □ | □ | +++ |
| Comparison 2 | 8 | +++ | □ | ◯ | □ | ± |

TABLE 2
Article to be washed: Lacquer coated bowl

| | | | Washing ability | | | |
|---|---|---|---|---|---|---|
| | | | | | Salad | Corro- |
| Polymer | pH | Foaming | Mayonnaise | Ketchup | Oil | siveness |
| Polymer 1 | 4 | − | X | Δ | X | − |
| | 5 | − | Δ | Δ | Δ | − |
| | 6 | − | □ | □ | □ | − |
| | 7 | − | ◯ | ◯ | ◯ | − |
| | 8 | ± | ◯ | ◯ | ◯ | ± |
| | 9 | ± | ◯ | ◯ | ◯ | ± |
| | 10 | ± | ◯ | ◯ | ◯ | ± |
| | 11 | + | ◯ | ◯ | ◯ | + |
| Polymer 2 | 4 | − | X | Δ | X | − |
| | 5 | − | Δ | □ | Δ | − |
| | 6 | − | □ | ◯ | □ | − |
| | 7 | ± | ◯ | ◯ | ◯ | ± |
| | 8 | ± | ◯ | ◯ | ◯ | ± |
| | 9 | ± | ◯ | ◯ | ◯ | + |
| | 10 | ± | ◯ | ◯ | ◯ | + |
| | 11 | + | ◯ | ◯ | ◯ | ++ |
| Polymer 3 | 4 | − | Δ | Δ | Δ | − |
| | 5 | − | □ | ◯ | □ | − |
| | 6 | − | □ | ◯ | □ | − |
| | 7 | − | ◯ | ◯ | ◯ | − |
| | 8 | ± | ◯ | ◯ | ◯ | ± |
| | 9 | ± | ◯ | ◯ | ◯ | ± |
| | 10 | ± | ◯ | ◯ | ◯ | + |
| | 11 | + | ◯ | ◯ | ◯ | + |
| Comparison 1 | 11 | + | Δ | Δ | Δ | +++ |
| Comparison 2 | 8 | +++ | □ | ◯ | □ | ± |

TABLE 3
Article to be washed: Urethane resin coated bowl

| | | | Washing ability | | | |
|---|---|---|---|---|---|---|
| | | | | | Salad | Corro- |
| Polymer | pH | Foaming | Mayonnaise | Ketchup | Oil | siveness |
| Polymer 1 | 4 | − | X | Δ | X | − |
| | 5 | − | Δ | □ | Δ | − |
| | 6 | − | □ | ◯ | □ | − |
| | 7 | − | ◯ | ◯ | ◯ | − |
| | 8 | ± | ◯ | ◯ | ◯ | − |
| | 9 | ± | ◯ | ◯ | ◯ | ± |
| | 10 | ± | ◯ | ◯ | ◯ | ± |
| | 11 | ± | ◯ | ◯ | ◯ | + |
| Polymer 2 | 4 | − | Δ | Δ | Δ | − |
| | 5 | − | □ | ◯ | □ | − |
| | 6 | − | ◯ | ◯ | ◯ | − |
| | 7 | ± | ◯ | ◯ | ◯ | − |
| | 8 | ± | ◯ | ◯ | ◯ | ± |
| | 9 | ± | ◯ | ◯ | ◯ | ± |
| | 10 | ± | ◯ | ◯ | ◯ | ± |
| | 11 | + | ◯ | ◯ | ◯ | + |
| Polymer 3 | 4 | − | Δ | □ | Δ | − |
| | 5 | − | □ | ◯ | □ | − |
| | 6 | − | ◯ | ◯ | ◯ | − |
| | 7 | − | ◯ | ◯ | ◯ | − |
| | 8 | ± | ◯ | ◯ | ◯ | − |
| | 9 | ± | ◯ | ◯ | ◯ | ± |
| | 10 | ± | ◯ | ◯ | ◯ | ± |
| | 11 | + | ◯ | ◯ | ◯ | + |
| Comparison 1 | 11 | + | Δ | □ | Δ | ++ |
| Comparison 2 | 8 | ++ | □ | ◯ | □ | ± |

Referring to the results in Tables 1, 2, and 3, foaming increases in accordance with ascending an pH in any kind of article to be washed, with foaming becoming noticeable at pH 11. Comparison 2, with the surface active agent being its main component, shows noticeable foaming.

Washing ability is not adequate below pH5, with oil based contaminants such as mayonnaise and salad oil, likely to remain.

Concerning corrosion test, corrosion becomes more noticeable with ascending pH in any kind of article to be washed, becoming obvious at pH11.

Further, pH range of comparison 1 is 11, at which corrosion becomes obvious.

### EXAMPLE 6

(Preparation of Washing Solution)

The solutions of polymers 1 and 2 prepared in EXAMPLES 1 and 2 were diluted with water to be 9% by weight of said polymer concentration, after which 4% by weight of sodium sulfate alkyl ether was added to said dilute solution.

The next solution of polymer 3 prepared in EXAMPLE 3 was diluted with water to be 9% by weight of said polymer concentration, after which 4% by weight of polyoxyethylene alkyl ether was added to said dilute solution.

The pH of each solution was adjusted to be 9 with sodium hydroxide.

Methyl modified cyclodextrin (MeCD), hydroxyl propyl modified cyclodextrin (HPCD), maltose modified cyclodextrin (MTCD), bentonite, titanium dioxide zeolite, and sodium sulfate were respectively added to the resulting solution of polymer 1 as shown in Table 4.

Further, 2 parts by weight of MeCD was respectively added to 100 parts by weight of the resulting solutions of polymers 2 and 3 to prepare samples No.15 and 16.

| | Sample No. | | | | | | | |
|---|---|---|---|---|---|---|---|---|
| Ingredient | 1 | 2 | 3 | 4 | 5 | 6 | 7 | 8 |
| Solution of | 100 | 100 | 100 | 100 | 100 | 100 | 100 | 100 |
| polymer 1 | | | | | | | | |
| Solution of | | | | | | | | |
| polymer 2 | | | | | | | | |
| Solution of | | | | | | | | |
| polymer 3 | | | | | | | | |
| MeCD | 1 | 2 | 3 | | | | | |
| HPCD | | | | 1 | 2 | 3 | | |
| MTCD | | | | | | | 1 | 2 |
| Bentonite | | | | | | | | |
| Titanium Oxide | | | | | | | | |
| Zeolite | | | | | | | | |
| Sodium sulfate | | | | | | | | |
| | Sample No. | | | | | | | |
| Ingredient | 9 | 10 | 11 | 12 | 13 | 14 | 15 | 16 |
| Solution of | 100 | 100 | 100 | 100 | 100 | 100 | | |
| polymer 1 | | | | | | | | |
| Solution of | | | | | | | 100 | |
| polymer 2 | | | | | | | | |
| Solution of | | | | | | | | 100 |
| polymer 3 | | | | | | | | |
| MeCD | | 1 | | | | | 2 | 2 |
| HPCD | | 1 | | | | | | |
| MTCD | 3 | | | | | | | |
| Bentonite | | | 3 | | | | | |
| Titanium Oxide | | | | 0.5 | | | | |
| Zeolite | | | | | 1 | | | |
| Sodium sulfate | | | | | | 10 | | |

### EXAMPLE 7

(Washing Test)

Sample solutions 1 to 16, prepared in EXAMPLE 6, were respectively diluted with water at 1000 times, and the pH of the resulting dilute solutions were respectively adjusted to be 7 with sodium hydroxide to prepare test washing solution, and washing tests the same as in EXAMPLE 5 were carried out. Glass was used as a material to be washed, with mayonnaise being was selected as the contaminate. The results of said washing test are shown in Table 5. Evaluations of the test results are the same in EXAMPLE 5.

TABLE 5

| | Sample No. | | | | | | | |
|---|---|---|---|---|---|---|---|---|
| Test Item | 1 | 2 | 3 | 4 | 5 | 6 | 7 | 8 |
| Stability of solution | ◯ | ◯ | ◯ | ◯ | ◯ | ◯ | ◯ | ◯ |
| Viscosity of solution | ◯ | ◯ | ◯ | ◯ | ◯ | ◯ | ◯ | ◯ |
| Foaming | ± | ± | ± | ± | + | + | − | − |
| Washing ability | □ | □ | ◯ | □ | ◯ | ◯ | □ | □ |
| Corrosiveness | − | − | − | − | − | − | − | − |
| | Sample No. | | | | | | | |
| Test Item | 9 | 10 | 11 | 12 | 13 | 14 | 15 | 16 |
| Stability of solution | ◯ | ◯ | ◯ | ◯ | Δ | ◯ | ◯ | ◯ |
| Viscosity of solution | ◯ | ◯ | ◯ | ◯ | ◯ | ◯ | ◯ | ◯ |
| Foaming | − | ± | − | − | − | − | ± | ± |
| Washing ability | □ | ◯ | ◯ | ◯ | ◯ | ◯ | ◯ | □ |
| Situation of | − | − | − | − | − | − | ± | ± |
| corrosion | | | | | | | | |

Referring to Table 5, it is recognized that the foaming of each sample is not noticeable with each sample having ample washing ability and negligible corrosive properties.

### EXAMPLE 8

The effect on washing ability of each washing agent for automatic dishwashers, said agents containing water soluble polymer as their main component, to which amylase was added, as shown in FIG. 6, was evaluated, the methods of evaluation being as follows.

Evaluation methods are as follows.

Contaminant: boiled rice

Article to be washed: a ceramic dish

Washing method: (1) Boiled rice was dissolved in hot water to prepare a boiled rice solution.
Said boiled rice solution was repeatedly coated on the surface of the dish (article to be washed) with a brush
(2) Said dish, on the surface of which said boiled rice solution was coated, was kept in a constant temperature chamber at 40° C., for 30 minutes, to dry the surface of said dish.
(3) Said dish was then washed in an automatic dishwasher, using a 1000 times diluted solution of washing solutions, having a composition as described below.

Evaluation of washing ability: Contaminants on the surface of each dish was visually observed by the color produced by the iodine-starch reaction, thereon.

Evaluation results are shown in Table 6.

TABLE 6

| Sample | Compound | Additional | Washing |
|---|---|---|---|
| No. | ingredients | amounts (%) | ability |
| 20 | Polyacrylic acid | 10 | X |
| | Amylase | 0 | |
| | Water | Balance | |
| 21 | Polyacrylic acid | 10 | X |
| | Amylase | 0.05 | |
| | Water | Balance | |
| 22 | Polyacrylic acid | 10 | Δ |
| | Amylase | 0.1 | |
| | Water | Balance | |
| 23 | Polyacrylic acid | 10 | ◯ |
| | Amylase | 0.5 | |
| | Water | Balance | |
| 24 | Polyacrylic acid | 10 | ◯ |
| | Amylase | 1.0 | |
| | Water | Balance | |

X: noticeable color produced
Δ: slight color produced
◯: almost no color produced

Referring to Table 6, it is recognized that in the case where more than 1 part by weight of amylase was added to 100 parts by weight of polyacrylic acid, the effect of the additional amylase became noticeable.

### INDUSTRIAL UTILITY

The washing agent of the present invention foams little, and is negligibly corrosive to ceramics, glass, and plastics, and is useful as a washing agent for automatic dishwashers.

1. A washing agent for an automatic dishwasher, containing a homopolymer of a vinyl monomer having a hydrophilic group or a copolymer of said vinyl monomer having a hydrophilic group and another vinyl monomer, wherein 30 to 70% by weight of said hydrophilic group is contained in said vinyl monomer and the pH of the 120 ppm aqueous solution of said homopolymer or said copolymer is in the range of between 5 and 10.

2. A washing agent for an automatic dishwasher in accordance with claim 1, wherein said hydrophilic group is a carboxyl group.

3. A washing agent for an automatic dishwasher in accordance with claim 1, wherein weight average molecular weight of said homopolymer or said copolymer is in the range of between 500 and 500,000.

4. A washing agent for an automatic dishwasher in accordance with claim 1, wherein water soluble polysaccharide and/or a derivative thereof, such as cyclodextrin and/or a derivative thereof or the like, is (are) further added to said washing agent.

5. A washing agent for an automatic dishwasher in accordance with claim 1, wherein an inorganic salt such as sodium sulfate or the like is further added to said washing agent.

6. A washing agent for an automatic dishwasher in accordance with claim 1, wherein an enzyme is further added to said washing agent.

7. A washing agent for an automatic dishwasher in accordance with claim 2, wherein weight average molecular weight of said homopolymer or said copolymer is in the range of between 500 and 500,000.

8. A washing agent for an automatic dishwasher in accordance with claim 2, wherein water soluble polysaccharide and/or a derivative thereof, such as cyclodextrin and/or a derivative thereof or the like, is (are) further added to said washing agent.

9. A washing agent for an automatic dishwasher in accordance with claim 3, wherein water soluble polysaccharide and/or a derivative thereof, such as cyclodextrin and/or a derivative thereof or the like, is (are) further added to said washing agent.

10. A washing agent for an automatic dishwasher in accordance with claim 2, wherein an inorganic salt such as sodium sulfate or the like is further added to said washing agent.

11. A washing agent for an automatic dishwasher in accordance with claim 3, wherein an inorganic salt such as sodium sulfate or the like is further added to said washing agent.

12. A washing agent for an automatic dishwasher in accordance with claim 4, wherein an inorganic salt such as sodium sulfate or the like is further added to said washing agent.

13. A washing agent for an automatic dishwasher in accordance with claim 2, wherein an enzyme is further added to said washing agent.

14. A washing agent for an automatic dishwasher in accordance with claim 3, wherein an enzyme is further added to said washing agent.

15. A washing agent for an automatic dishwasher in accordance with claim 4, wherein an enzyme is further added to said washing agent.

16. A washing agent for an automatic dishwasher in accordance with claim 5, wherein an enzyme is further added to said washing agent.
